(19) United States
(12) Patent Application Publication
(10) Pub. No.: US 2008/0233892 A1
(43) Pub. Date: Sep. 25, 2008

(54) METHOD AND SYSTEM FOR AN INTEGRATED VCO AND LOCAL OSCILLATOR ARCHITECTURE FOR AN INTEGRATED FM TRANSMITTER AND FM RECEIVER

(76) Inventors: Bojko Marholev, Irvine, CA (US); Lijun Zhang, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/842,429

(22) Filed: Aug. 21, 2007

Related U.S. Application Data
(60) Provisional application No. 60/895,665, filed on Mar. 19, 2007.
(60) Provisional application No. 60/895,667, filed on Mar. 19, 2007.

(51) Int. Cl. H04B 1/40

(52) U.S. Cl. 455/77

(57) ABSTRACT

Aspects of a method and system for an integrated local oscillator generator for an integrated FM radio are provided. In this regard, a FM radio receive path and/or a FM radio transmit path may utilize one or more signals which are a frequency scaled version of a generated signal. In this regard, the frequency scaling may be performed by one or more configurable frequency dividers which may be programmably controlled by a processor. The generated signal may be in the range of about 990 MHz to 1190 MHz such that harmonics of the generated signal do not interfere with coexistent wireless technologies. Additionally the frequency scaled version may be in the frequency range of about 76 MHz to 108 MHz such that FM Radio signals in a FM broadcast band may be transmitted and/or received. The frequency scaled versions of the generated signal may comprise in-phase and quadrature components and may be utilized to up-convert and/or down-convert FM radio signals.

### CROSS-REFERENCE TO RELATED APPLICATIONS/INCORPORATION BY REFERENCE

This patent application makes reference to, claims priority to and claims benefit from U.S. Provisional Patent Application Ser. No. 60895665 filed on Mar. 19, 2007.

This patent application also makes reference to, claims priority to and claims benefit from U.S. Provisional patent application Ser. No. 60895667 filed on Mar. 19, 2007.

Each of the above stated applications is hereby incorporated herein by reference in its entirety.

### FIELD OF THE INVENTION

Certain embodiments of the invention relate to signal processing. More specifically, certain embodiments of the invention relate to a method and system for an integrated frequency synthesizer for an integrated FM radio.

### BACKGROUND OF THE INVENTION

With the increasing popularity of various wireless standards and technologies, there is a growing demand to provide a simple and complete solution for wireless communications applications. In this regard, electronics manufacturers are increasingly attempting to incorporate multiple wireless technologies into portable electronic devices. For example, wireless technologies that are seeing widespread deployment include FM radio, Bluetooth (BT), GPS, Wi-Fi, and RFID.

Although desirable to users, incorporating multiple wireless communication technologies into devices such as wireless handsets may pose problems in terms of cost and complexity. In this regard, combining a plurality of wireless technologies into a portable electronic device may require separate processing hardware and/or separate processing software. Moreover, coordinating the reception and/or transmission of data to and/or from the portable electronic device may require significant processing overhead that may impose certain operation restrictions and/or design challenges.

Furthermore, simultaneous use of a plurality of radios in a handheld may result in significant increases in power consumption.

Another complication associated with incorporating multiple wireless technologies in a single device is that each radio often requires a number of analog components for signal generation, filtering, and other purposes. Consequently, space may quickly become limited as analog blocks, such as PLLs, may require a significant amount of area, particularly at relatively low frequencies.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a frequency synthesizer architecture for an integrated FM radio, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram of an exemplary portable electronic device comprising integrated support for multiple wireless technologies, in accordance with an embodiment of the invention.

FIG. 2 is a block diagram of an exemplary single chip with multiple integrated wireless technologies, in accordance with an embodiment of the invention.

FIG. 3 is a block diagram of an exemplary FM radio, in accordance with an embodiment of the invention.

FIG. 4a is a block diagram illustrating LO generation for a FM radio, in connection with an embodiment of the invention.

FIG. 4b is a diagram illustrating selection of a VCO frequency for generating signals utilized by an integrated FM radio, in accordance with an embodiment of the invention.

FIG. 4c is a block diagram illustrating LO generation for an integrated FM radio, in accordance with an embodiment of the invention.

FIG. 5 is a block diagram of an integrated frequency synthesizer for an integrated FM radio in accordance with an embodiment of the invention.

### DETAILED DESCRIPTION OF THE INVENTION

Certain embodiments of the invention may be found in a method and system for an integrated frequency synthesizer for an integrated FM radio. The FM radio may comprise an integrated FM radio transmitter and/or a FM radio receiver.

Aspects of a method and system for an integrated local oscillator generator for an integrated FM radio are provided. In this regard, a FM radio receive path and/or a FM radio transmit path may utilize one or more signals which are a frequency scaled version of a generated signal. In this regard, the frequency scaling may be performed by one or more configurable frequency dividers which may be programmably controlled by a processor. The generated signal may be in the range of about 990 MHz to 1190 MHz such that harmonics of the generated signal do not interfere with coexistent wireless technologies. Additionally the frequency scaled version may be in the frequency range of about 76 MHz to 108 MHz such that FM Radio signals in a FM broadcast band may be transmitted and/or received. The frequency scaled versions of the generated signal may comprise in-phase and quadrature components and may be utilized to up-convert and/or down-convert FM radio signals.

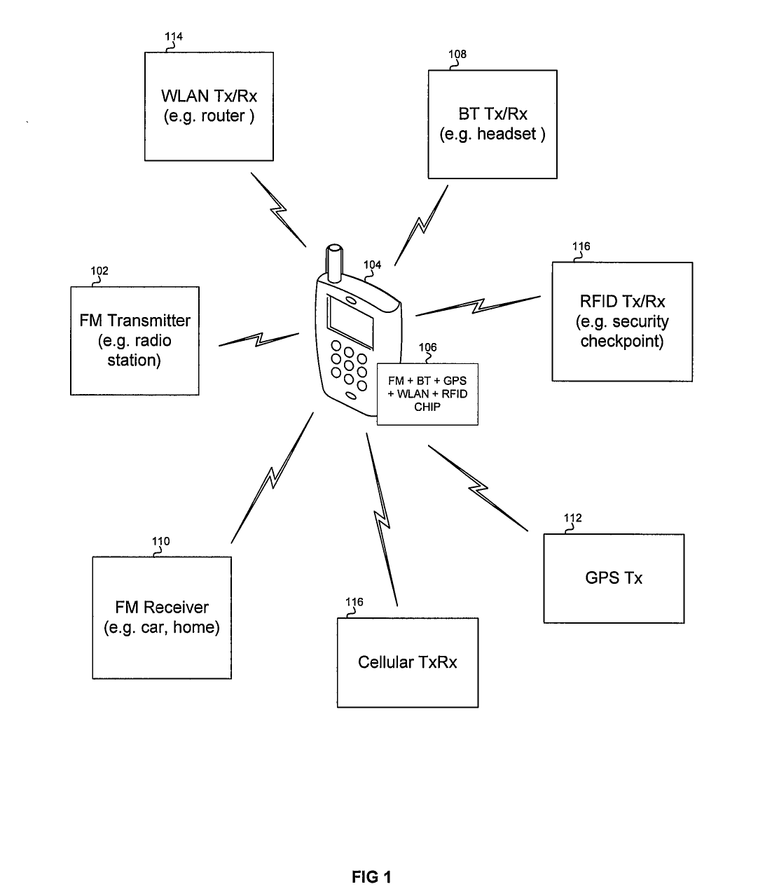

FIG. 1 is a diagram of an exemplary portable electronic device comprising integrated support for multiple wireless technologies, in accordance with an embodiment of the invention. Referring to FIG. 1 there is shown a smart phone 104, a FM radio transmitter 102, a FM radio receiver 110, WLAN transceiver 114, BT transceiver 108, an RFID Transceiver 116, and a GPS transmitter 112.

The FM radio transmitter 102 may, for example, transmit FM radio signals in the “FM broadcast band” of approximately 76 MHz to 108 MHz. In this regard, the FM radio transmitter 102 may be implemented as part of a radio station. The FM receiver 110 may, for example, receive signals in the “FM broadcast band” of approximately 76 MHz to 108 MHz. In this regard, the FM radio receiver 110 may be implemented as part of a home or car stereo system. The WLAN transceiver 114 may, for example, transmit and receive signals adhering to a wireless standard such as the IEEE 802.11 family of standards. In this regard, the WLAN transceiver may be implemented as part of a wireless router and may operate at a frequency around 2.4 GHz or 5 GHz. The Bluetooth transceiver 108 may, for example, adhere to one or more Bluetooth standards transmitting and receiving RF signals at or near 2.4 GHz. In this regard, the Bluetooth transceiver 108 may be implemented as part of a wireless headset utilized to transfer voice and/or audio information to/from the smart phone 104. The RFID transceiver 116 may, for example, transmit and/or receive RF signals at or near 900 MHz. In this regard, the RFID transceiver 116 may be implemented as part of a security checkpoint which may provide restricted access to one or more resources requiring a person to present a valid ID in the form of an RFID device or badge. The GPS transmitter may, for example, transmit RF signals at 1227.6 MHz and 1575.42 MHz. The GPS transmitter may be implemented as part of a satellite. The cellular transmitter 116 may, for example, transmit and receiver RF signals in the frequency band from 776 MHz to 960 MHz. In this regard, the cellular transceiver 116 may be implemented as part of a base station.

The smart phone 104 may comprise a multi-function wireless chip 106 that may comprise suitable logic, circuitry, and/or code that may enable the smart phone to communicate with one or more of the FM radio transmitter 102, the FM radio receiver 110, the WLAN transceiver 114, the BT transceiver 108, the RFID Transceiver 116, the GPS transmitter 112, and the cellular transceiver 116. The chip 106 may be enabled to transmit and/or receive RF signals in a multitude of frequency bands utilizing a multitude of modulation and/or encoding techniques. Accordingly, the chip 106 may utilize advanced and/or specialized signal processing techniques in order to minimize interference between the various wireless technologies. For example, the chip 106 may generate LO signals for FM radio transmission and/or FM radio reception in such a way that harmonics in critical frequency bands are small. In this regard, LO signals for FM radio transmission and/or reception may be generated by dividing down, via a variable frequency divider, an output of a VCO operating at a frequency higher than FM broadcast band. The chip 106 may utilize advanced and/or specialized techniques for minimizing the area of the circuitry required to implement each of the wireless technologies.

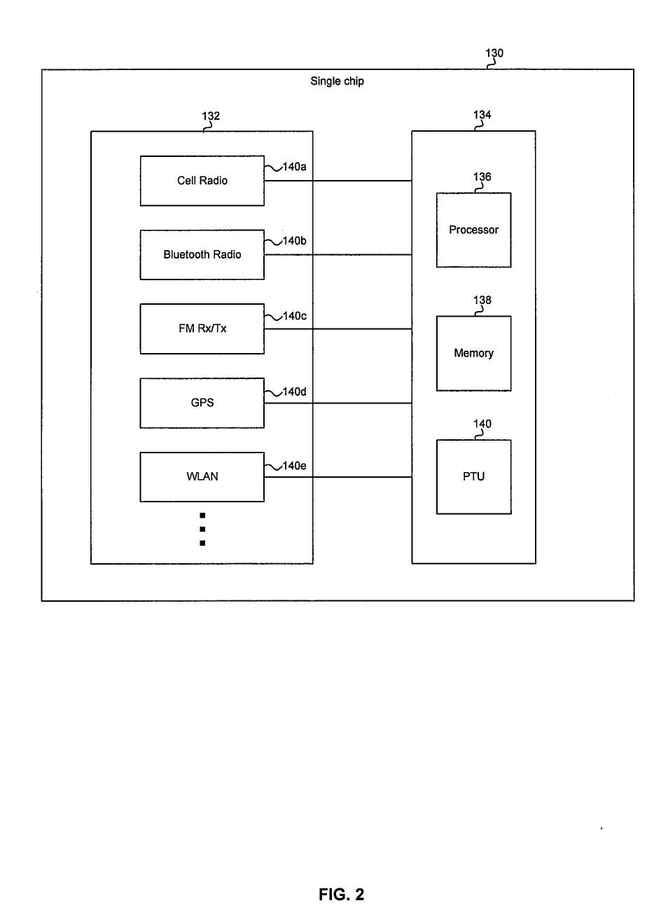

FIG. 2 is a block diagram of an exemplary single chip with multiple integrated wireless technologies, in accordance with an embodiment of the invention. Referring to FIG. 2, there is shown a single chip 130 that may comprise a radio portion 132 and a processing portion 134. The radio portion 132 may comprise a plurality of integrated radios. For example, the radio portion 132 may comprise a cell radio 140a that supports cellular communications, a Bluetooth radio 140b that supports Bluetooth communications, an FM receive and transmit (Rx/Tx) radio 140c that supports FM radio communications, a global positioning system (GPS) 140d that supports GPS communications, and/or a wireless local area network (WLAN) 140e that supports communications based on the IEEE 802.11 standards.

The processing portion 134 may comprise at least one processor 136, a memory 138, and a peripheral transport unit (PTU) 140. The processor 136 may comprise suitable logic, circuitry, and/or code that may enable processing of data received from the radio portion 132. In this regard, each of the integrated radios may communicate with the processing portion 134. In some instances, the integrated radios may communicate with the processing portion 134 via a common bus, for example. In various embodiments of the invention, the processor 136 may, for example, enable programmably controlling one or more frequency dividers to control the LO frequency utilized for FM radio transmission and/or reception. The memory 138 may comprise suitable logic, circuitry, and/or code that enable storage of data that may be utilized by the processor 136. In this regard, the memory 138 may store at least a portion of the data received by at least one of the integrated radios in the radio portion 132. Moreover, the memory 138 may store at least a portion of the data that may be transmitted by at least one of the integrated radios in the radio portion 132. Additionally, the memory 138 may, for example, store data utilized in determining a frequency scaling factor in order to divide a VCO output down to a desired FM radio frequency. The PTU 140 may comprise suitable logic, circuitry, and/or code that may enable interfacing data in the single chip 130 with other devices that may be communicatively coupled to the single chip 130. In this regard, the PTU 140 may support analog and/or digital interfaces.

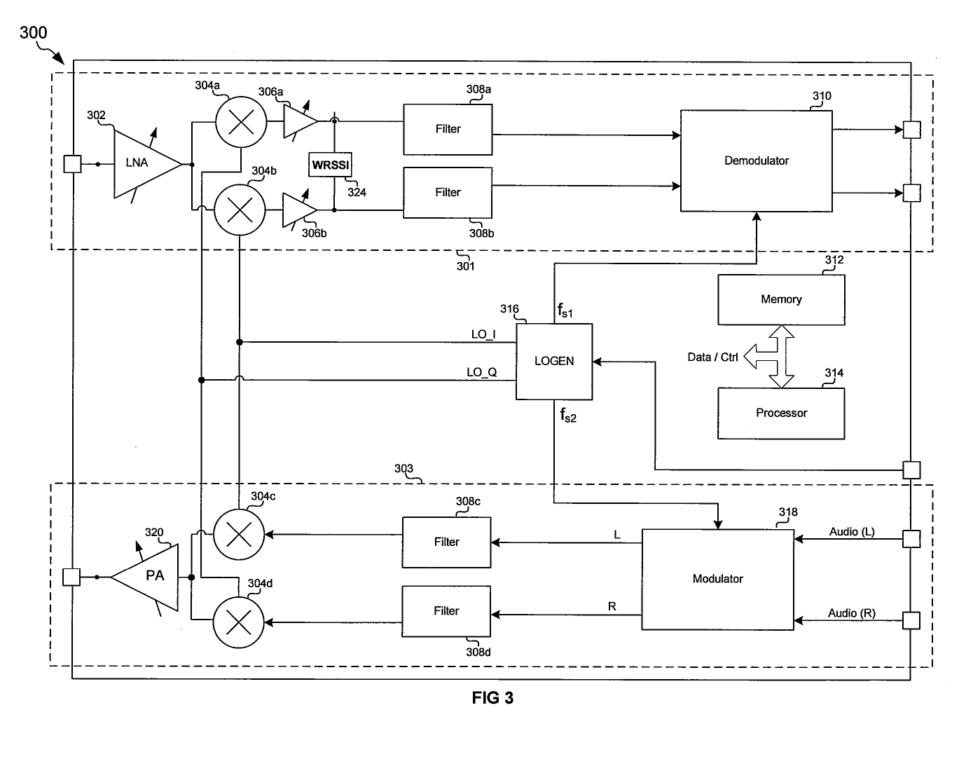

FIG. 3 is a block diagram of an exemplary FM radio, in accordance with an embodiment of the invention. Referring to FIG. 3, the radio may comprise a receive path 301, a transmit path 303, a local oscillator generator 316, a memory 312, and a processor 314.

The FM radio receive path 301 may comprise suitable logic, circuitry, and/or code that may enable the FM radio 300 to receive FM radio signals, for example, in the “FM broadcast band,” or approximately 76 MHz to 108 MHz. In one embodiment of the invention, the receive chain may comprise a low noise amplifier (LNA) 302, a plurality of mixers 304a and 304b, a plurality of intermediate frequency (IF) amplifiers 306a and 306b, a wideband received signal strength indicator (WRSSI) 324, a plurality of filters 308a and 308b, and a demodulator 310.

The LNA 302 may comprise suitable logic, circuitry, and/or code that may enable buffering and/or amplification of received RF signals. In this regard, the gain of the LNA 302 may be adjustable to enable reception of signals of varying strength. Accordingly, the LNA 302 may receive one or more control signals from the processor 314.

The mixers 304a and 304b may each comprise suitable logic, circuitry, and/or code that may enable generation of inter-modulation products resulting from the mixing of a received RF signal and a local oscillator signal. The mixer 304a may, for example, be enabled to utilize an in-phase LO signal to generate in-phase inter-modulation products. The mixer 304b may, for example, be enabled to utilize a quadrature phase LO signal to generate quadrature phase inter-modulation products. The frequency of the LO signals may be determined based on the desired received radio frequency. In this regard, the mixers 304a and 304b may enable down-converting received RF signals of varying frequency to a fixed intermediate frequency (IF). The intermediate frequency may, for example, be chosen to be a frequency that is conducive to signal processing and/or does not result in interference with other circuits integrated into a chip such as the chip 130 of FIG. 2.

The IF amplifiers 306a and 306b may comprise suitable logic, circuitry, and/or code that may enable amplification and/or buffering of signals at or near a desired intermediate frequency. In this regard, the gain of each of the IF amplifiers 306a and 306b may be adjustable and may enable receiving signals of varying strength. Accordingly, the IF amplifiers 306a and 306b may each receive one or more control signals from the processor 314.

The wideband received signal strength indicator (WRSSI) 324 may comprise suitable logic, circuitry, and/or code that may enable determining the strength of a received RF signal and making this information available to the system 300 in the form of an analog and/or digital signal. Accordingly, the WRSSI 324 may, for example, enable the processor 314 to adjust various control signals in response to received signals strength.

The filters 308a and 308b may comprise suitable, logic, and/or code that may enable passing frequencies at or neat the IF and attenuating other frequencies. The bandwidth of the filters may, for example, be suitable for passing a composite FM multiplex comprising stereo audio and RDS data. In this regard, the bandwidth, attenuation, and/or center frequency of each of the filters 308a and 308b may be adjustable based on one or more control signals. Accordingly, the filters 308a and 308b may each receive one or more control signals from the processor 314.

The demodulator 310 may comprise suitable logic, circuitry, and/or code that may enable detection of information comprising a received frequency modulated signal. In this regard, the demodulator 310 may extract information impressed onto an RF carrier and may output this information as analog audio and/or RBDS data, for example. In this regard, the output may comprise left and right audio channels. The demodulator 310 may be enabled to communicate detected information to the memory 312. The demodulator 310 may receive one or more control signals from the processor 318.

The FM radio transmit path 303 may comprise suitable logic, circuitry, and/or code that may enable the FM radio 300 to transmit FM radio signals, for example, in the “FM broadcast band”, or approximately 76 MHz to 108 MHz. In an exemplary embodiment of the invention, the transmit chain 303 may comprise a modulator 318, a plurality of filters 308c and 308d, a plurality of mixers 304c and 304d, and a power amplifier (PA) 320.

The modulator 318 may comprise suitable logic, circuitry, and/or code that may, for example, enable frequency modulation of an IF carrier with analog audio and/or RDS data that is to be transmitted by the radio 300. In this regard, data to be transmitted may, for example, be passed to the modulator 318 from the memory 312 or may be received from an external audio source. Accordingly, the modulator may enable processing a right audio channel and a left audio channel and may output two corresponding signals. The modulator 318 may receive information and or control data from the processor 314 and/or the memory 312.

The filters 306c and 306d may comprise suitable, logic, and/or code that may enable passing frequencies at or near the IF and attenuating other frequencies. In this regard, the bandwidth, attenuation, and/or center frequency of each of the filters 308c and 308d may be adjustable based on one or more control signals. Accordingly, the filters 308c and 308d may each receive one or more control signals from the processor 314.

The mixers 304c and 304d may each comprise suitable logic, circuitry, and/or code that may enable generation of inter-modulation products resulting from the mixing of a IF signal and a local oscillator signal. The mixer 304c may, for example, be enabled to utilize an in-phase LO signal to generate in-phase inter-modulation products. The mixer 304b may, for example, be enabled to utilize a quadrature phase LO signal to generate quadrature phase inter-modulation products. The frequency of the LO signals may be determined based on the desired transmitted radio frequency. In this regard, the mixers 304c and 304d may enable up-converting an IF signal to an RF signal, for example, in the “FM broadcast band”, or approximately 76 MHz to 108 MHz. The IF may, for example, be chosen to be a frequency conducive to signal processing and/or does not result in interference with other circuits comprising a chip such as the chip 130 of FIG. 2.

The PA 320 may comprise suitable logic, circuitry, and/or code that may enable buffering and/or amplification of a FM radio RF signal and outputting the signal to an antenna for transmission. In this regard, the gain of the PA 320 may be adjustable and may enable transmitting signals of varying strength. Accordingly, the PA 320 may receive one or more control signals from the processor 314.

The local oscillator generator (LOGEN) 316 may comprise suitable logic, circuitry, and/or code that may enable generation of one or more signals of varying frequency. In this regard, the LOGEN 316 may be enabled to generate local oscillator frequencies which may be utilized in up-converting FM radio signals for transmission and down-converting received FM radio signals. The LOGEN 316 may be enabled to generate pairs of signals in phase quadrature. Additionally, the LOGEN 316 may generate one or more signals utilized by the modulator 318 and/or the demodulator 310. In this regard, the LOGEN 316 may, for example, generate one or more sampling frequencies utilized by analog-to-digital converters and/or digital-to-analog converters comprising the modulator 318 and/or the demodulator 310. The LOGEN 316 may generate signals of variable frequency based on a fixed-frequency reference signal. In this regard, the LOGEN 316 may be configurable and may receive one or more control signals from the processor 314.

The memory 312 may comprise suitable logic, circuitry, and/or code that may enable storing data that may be utilized for transmission and/or reception of FM radio signals. In this regard, the memory 312 may, for example, enable storing received audio and/or RDS data. Similarly, the memory 312 may enable storing digital audio and or RDS data that is to be transmitted. Additionally, the memory 312 may enable storing data utilized in configuring the various blocks of the FM radio 300. Accordingly, the memory 312 may receive one or more control signals from the processor 312.

The processor 314 may comprise suitable logic, circuitry, and/or code that may enable configuring and/or controlling the FM radio 300. In this regard, the processor 314 may be enabled to execute one or more instructions that may enable providing one or more control signals to the various blocks comprising the FM radio 300. Furthermore, the processor 312 may be enabled to control the exchange of data between the memory 312 and the various other blocks of the FM radio 300.

In an exemplary receive operation, the FM radio 300 may be configured to transmit FM radio signals or to receive FM radio signals. To receive FM radio signals, the processor 314 may provide one or more control signals that power down the blocks comprising the FM radio transmit path 303 and power up the blocks comprising the FM radio receive path 301. Additionally, the LOGEN 316 may be configured to generate a pair of LO signals at an appropriate frequency for down-converting the desired frequency band to the IF. The LNA 302 may amplify a received signal. The amplified signal may then be provided to the two mixers 304a and 304b which may utilize the pair of LO signals to generate in-phase and quadrature phase IF signals. The IF signals may be amplified by the IF amplifiers 306a and 306b. The filters 308a and 308b may filter out the undesired mixer products and pass the desired IF frequency. The demodulator 310 may extract the information contained in the frequency modulated IF signal and may output the extracted information. Additionally, the extracted data may be stored in the memory 312.

In an exemplary transmit operation, the processor 314 may provide one or more control signals that power down the blocks comprising the FM radio receive path 301 and power up the blocks comprising the receive path 303. Additionally, the LOGEN 316 may be configured to generate a pair of LO signals at an appropriate frequency for up converting the IF to the desired RF transmit frequency. The modulator 318 may receive an analog stereo (left and right) signals and may frequency modulate an IF carrier by each signal. Accordingly, the modulator may output a left IF channel and a right IF channel. Each IF signal may pass through one of the filters 308c and 308d where undesired frequencies may be attenuated. The mixers 304c and 304d may up-convert the filtered IF signals to the desired RF transmit frequency. The two channels comprising the up-converted signal may be combined into a composite stereo signal that may be transmitted via an antenna.

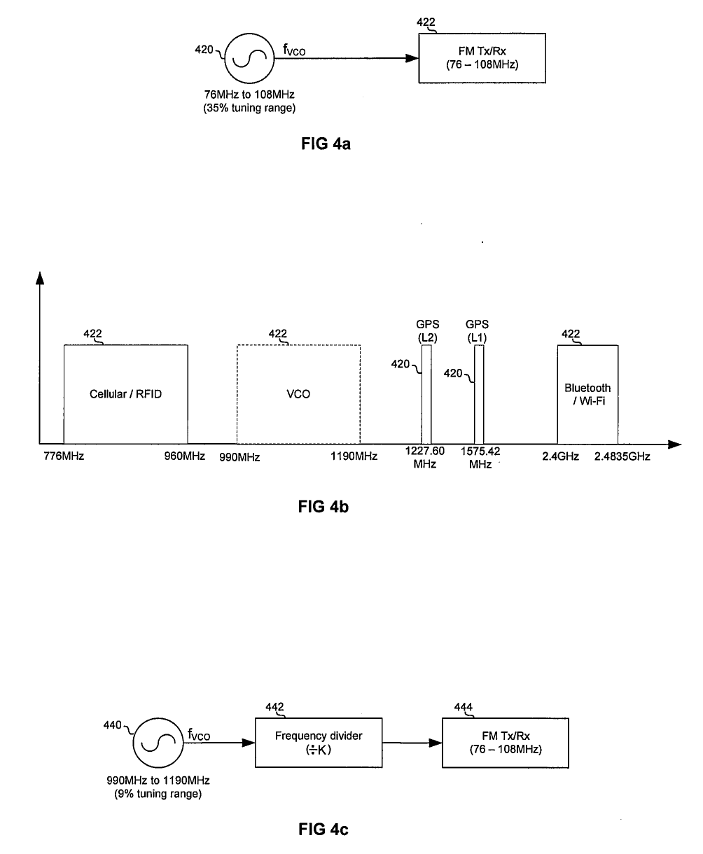

FIG. 4a is a block diagram illustrating LO generation for a FM radio, in connection with an embodiment of the invention. Referring to FIG. 4a, there is shown a VCO 420 and an FM radio 422.

The VCO 420 may comprise suitable logic, circuitry, and/or code that may enable outputting a frequency based on a control signal applied to the VCO 408. In this regard, the output frequency of the VCO 408 may be controlled by an analog voltage and/or digital value corresponding to a voltage. Accordingly, the VCO 408 may receive one or more control signals from a processor, such as the processor 314 disclosed in FIG. 3.

The FM radio 422 may comprise suitable logic, circuitry, and/or code that may enable transmitting and/or receiving signals in the “FM broadcast band”, or approximately 76 MHz to 108 MHz. In this regard, the FM radio 422 may utilize one or more LO signals for processing received FM radio signals and/or for processing FM radio signals to be transmitted.

In operation, generating LO signals in a manner shown in FIG. 4a may have several drawbacks. A first drawback of the circuit in FIG. 4a is that the VCO is required to have tuning range that is 35% of the center frequency. In practice, designing a VCO to operate over this range of frequencies may pose several complications and may lead to a more complex and/or costly circuit. A second drawback of the system shown in FIG. 4a may occur if the system in integrated into a chip such as the chip 130 of FIG. 2. In this regard, because the FM radio band is relatively low in frequency, harmonics of the VCO frequency may cause interference with other integrated wireless technologies. This is further illustrated in FIG. 4b where the frequency spectrum for various wireless technologies is shown.

FIG. 4b is a diagram illustrating selection of a VCO frequency for generating signals utilized by an integrated FM radio, in accordance with an embodiment of the invention. Referring to FIG. 4b it may be seen that a frequency band of 990 MHz to 1190 MHz may be a desirable operating range for a VCO generating LO frequencies for an integrated FM radio. In this regard, the frequency band of 990 MHz to 1190 MHz may not interfere with the frequency bands of other wireless technologies. Moreover, the harmonics of the frequency band 990 MHz to 1190 MHz may not interfere with the other wireless technologies. Accordingly, a VCO operating from 990 MHz to 1190 MHz may be well suited for operating in a chip such as the chip 130.

FIG. 4c is a block diagram illustrating LO generation for an integrated FM radio, in accordance with an embodiment of the invention. Referring to FIG. 4c, there is shown a VCO 440, a frequency divider 442, and a FM radio 444.

The FM radio 444 may comprise suitable logic, circuitry, and/or code that may enable transmitting and/or receiving FM radio signals. Depending on factors such as type of coexisting wireless technologies and country of operation the frequency range over which the FM radio 444 operates may vary. In one embodiment of the invention, for example, the FM radio may operate over the frequency range of 76 MHz to 108 MHz.

The VCO 440 may comprise suitable logic, circuitry, and/or code that may enable outputting a frequency based on a control signal applied to the VCO 408. In this regard, the output frequency of the VCO 408 may be controlled by an analog voltage and/or digital value corresponding to a voltage. Accordingly, the VCO 408 may receive one or more control signals from a processor, such as the processor 314 disclosed in FIG. 3.

The frequency divider 442 may comprise suitable logic, circuitry, and/or code that may enable receiving an input frequency and outputting one or more signals lower in frequency by a factor of 1/N. In this regard, the frequency divider 442 may be configurable such that the value of N may be determined based on the input frequency and a desired output frequency.

In operation the VCO 442 may operate at a frequency range higher than the desired LO frequency range. Additionally, by varying the factor K, the required operating range of the VCO may be narrowed. This narrowing may be achieved by dividing the VCO frequency band by different divider ratios. Actual band divisions may overlap as long as the VCO band does not interfere with other wireless bands. In an exemplary embodiment of the invention, the VCO may operate in the 990 MHz to 1190 MHz range identified in FIG. 4b. In this regard, the operating range of the VCO 442 may be 9% of the center frequency compared to the 35% for the VCO 420 in FIG. 4a. Accordingly, the design of the VCO may be simplified as compared to the VCO 420. To achieve the desired LO frequency, the VCO frequency and the value of K may be chosen according to table 1:

TABLE 1
Exemplary VCO frequencies and scaling factors

| Desired LO | K | VCO frequency |
|---|---|---|
| 76 MHz-85 MHz | 14 | 1064 MHz-1190 MHz |
| 85 MHz-99 MHz | 12 | 1020 MHz-1188 MHz |
| 99 MHz-108 MHz | 10 | 990 MHz-1080 MHz |

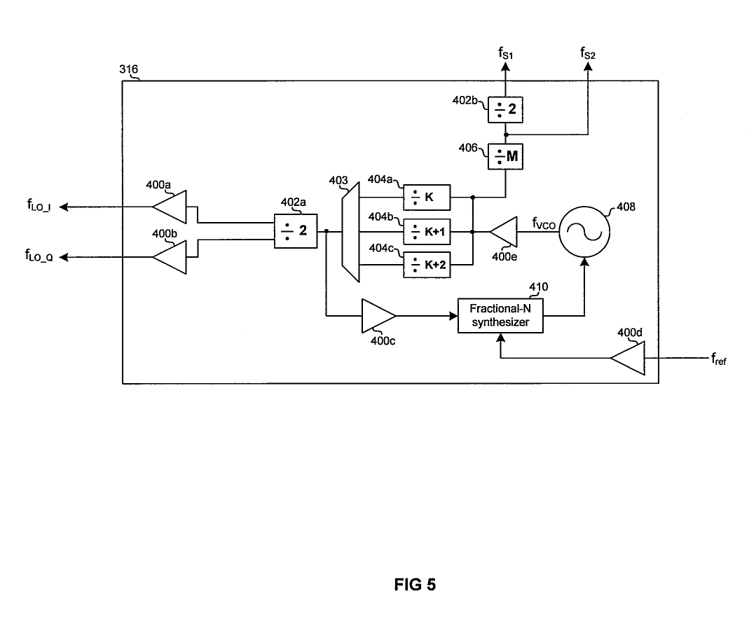

FIG. 5 is a block diagram of an integrated frequency synthesizer for an integrated FM radio, in accordance with an embodiment of the invention. Referring to FIG. 5, the LOGEN 316 may comprise a multitude of buffers 400, a phase shifter 401, a plurality of divide-by-two blocks 402, a divide-by-K block 404a, a divide-by-K+1 block 404b, a divide-by-K+2 block 404c, a divide-by-M block 406, a VCO 408, and a fractional N-synthesizer 410.

The buffers 400 may comprise suitable logic, circuitry, and/or code that may enable isolating two nodes of a circuit. In this regard, the buffers 400 may each comprise an input terminal and an output terminal and may be enabled to provide an impedance transformation from the input to the output. For example, the buffers may transfer a voltage from a circuit node having high impedance to a circuit node having low impedance.

The divide-by-two blocks 402 may comprise suitable logic, circuitry, and or code that may enable outputting a frequency that is half of a frequency input to the divide-by-two block 402. The divide-by-two block 402 may also generate in-phase and quadrature phase components.

The divide-by-K block 404a may comprise suitable logic, circuitry, and/or code that may enable outputting a frequency that is 1/K times a frequency input to the divide-by-K block 404a. The divide-by-(K+1) block 404b may comprise suitable logic, circuitry, and/or code that may enable outputting a frequency that is 1/(K+1) times a frequency input to the divide-by-(K+1) block 404b. The divide-by-(K+2) block 404c may comprise suitable logic, circuitry, and/or code that may enable outputting a frequency that is 1/(K+2) times a frequency input to the divide-by-(K+2) block 404c. Accordingly, K may be configurable and may be determined by one or more control signals. In this regard, a processor such as the processor 314 and/or a memory such as the memory 314 may enable generation of control signals to configure the value of K.

The divide-by-M block 406 may comprise suitable logic, circuitry, and/or code that may enable outputting a frequency that is 1/M times a frequency input to the divide-by-M block 406. Accordingly, M may be configurable and may be determined by one or more control signals. In this regard, a processor such as the processor 314 and/or a memory such as the memory 314 may enable generation of control signals to configure the value of M.

The VCO 408 may comprise suitable logic, circuitry, and/or code that may enable outputting a frequency based on a control signal applied to the VCO 408. In this regard, the output frequency of the VCO 408 may be controlled by an analog voltage and/or digital value corresponding to a voltage. Accordingly, the VCO 408 may receive one or more control signals from a processor, such as the processor 314 disclosed in FIG. 3.

The Fractional-N synthesizer 410 may comprise suitable logic, circuitry and/or code that may enable generation of signals of variable frequency based on a fixed reference frequency. In this regard, the frequency output by the fractional-N synthesizer 410 may be determined by the following relation:

fₒᵤₜ=f_{ref}×(N+ΔN), where 0≦ΔN≦1. EQ. 1

Accordingly, the frequencies output by the fractional-N synthesizer may be nearly independent of the reference frequency. The value of N and ΔN may be determined based on the desired RF receive or transmit frequency. In this regard, a processor and/or memory may be enabled to provide one or more control words to the fractional-N synthesizer to configure the value of N.

In operation, the frequency synthesizer 400 may generate a plurality of signals of varying frequencies based on a single fixed frequency reference signal. A crystal oscillator or similar stable reference may provide a reference frequency to the fractional-N synthesizer 410, via the buffer 400d. The fractional-N synthesizer 410 may generate a control signal that may control the frequency of the VCO 408. In this regard, the fractional-N synthesizer 410 may compare a feedback signal from the buffer 400c to the reference signal from the buffer 400d. The fractional-N synthesizer 410 may generate a voltage proportional to the phase error between the two signals. Accordingly, the voltage applied to the VCO 408 may be adjusted resulting in a change in the frequency output by the VCO 408. In this manner, the phase error between the feedback signal and the reference signal may be reduced to 0, plus or minus a tolerance.

The output of the VCO 408 may be applied to the divide-by-K block 404a, divide-by-(K+1) block 404b, and divide-by-(K+2) block 404c. The divided down signals may be input to the switching element 403. Accordingly, the switching element 403 may be enabled to select one of the divided outputs, based on one or more control signals. The output of the switching element 403 may then be further divided by 2 and may be split into a pair of signals in phase quadrature, resulting in a pair of LO signals in phase quadrature.

The output of the divide-by-2 block 402a may also feedback to the fractional-N synthesizer 410, via the buffer 400c. In this manner, the frequency of the feedback signal to the fractional-N synthesizer 410 may be twice the LO frequency.

The output of the VCO 408 may also be input to the divide-by-M block 406. The divide-by-M block 406 may thus output a signal fₛ₂. The signal fₛ₂ may be input to the divide-by-2 block 402b to output a signal fₛ₁. The signals fₛ₁ and fₛ₂ may, for example, be frequencies suitable for D-to-A and/or A-to-D conversion and may be utilized by a modulator block and/or demodulator block, such as the modulator block 318 and/or the demodulator block 310 disclosed in FIG. 3.

By changing N and/or by configuring the switching element 403 to select a different scale factor, the frequency of the LO signal may be modified. In this regard, N may be chosen such that the fractional-N synthesizer attempts to lock to a signal that is twice the desired LO frequency. Similarly, the value of K may be chosen based on the desired frequency of operation and tuning range of the VCO 408. In an exemplary embodiment of the invention, the VCO may operate over the frequency range of 990 MHz to 1190 MHz and K may be set to a value of 5. Accordingly, the switching element 403 may switch between division by 5, division by 6, and division by 7. In this manner, VCO frequency may be 10, 12, or 14 times the LO frequency as described above in table 1.

Aspects of a method and system for an integrated local oscillator generator for an integrated FM radio are provided. In this regard, a FM radio receive path, such as the receive path 301 and/or a FM radio transmit path, such as the transmit path 303, may utilize one or more signals which are a frequency scaled version of a generated signals, such as the signal fvco generated by the VCO 408 in FIG. 5. in this regard, the frequency scaling may be performed by one or more configurable frequency dividers, such as the dividers 402 and 404, which may be programmably controlled by a processor, such as the processor 314. The generated signal may be in the range of about 990 MHz to 1190 MHz such that harmonics of the generated signal do not interfere with coexistent wireless technologies. Additionally the frequency scaled version may be in the frequency range of about 76 MHz to 108 MHz such that FM Radio signals in a FM broadcast band may be transmitted and/or received. The frequency scaled versions of the generated signal may comprise in-phase and quadrature components and may be utilized to up-convert and/or down-convert FM radio signals.

Another embodiment of the invention may provide a machine-readable storage, having stored thereon, a computer program having at least one code section executable by a machine, thereby causing the machine to perform the steps as described herein for an integrated frequency synthesizer for an integrated FM radio.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising:
in an integrated FM radio transmitter and FM radio receiver system that shares a common local oscillator generator for driving said FM radio transmitter and said FM radio receiver:
generating within said local oscillator generator, a first signal; and
clocking said FM radio transmitter and said FM radio receiver via a frequency scaled version of said first signal.

2. The method according to claim 1, comprising programmably scaling a frequency of said generated local oscillator signal.

3. The method according to claim 1, wherein a frequency of said first signal is in a frequency range of about 990 MHz to 1190 MHz.

4. The method according to claim 1, wherein a frequency of said frequency scaled version of said first signal is in a frequency range of about 76 MHz to 108 MHz.

5. The method according to claim 1, wherein said scaled version of said first signal comprise an in-phase component and a quadrature component.

6. The method according to claim 1, comprising down-converting received FM radio signals utilizing said frequency scaled version of said first signal.

7. The method according to claim 1, comprising up-converting FM radio signals for transmission utilizing said frequency scaled version of said first signal.

8. The method according to claim 1, comprising receiving via said local oscillator generator, one or more signals generated via a fractional-N synthesizer.

9. The method according to claim 1, comprising clocking said fractional-N synthesizer via a frequency scaled version of said first signal.

10. The method according to claim 1, wherein a frequency of said first signal is selected so that at least a first harmonic of said first signal does not fall within a frequency band utilized by a coexistent wireless technology.

11. A machine-readable storage having stored thereon, a computer program having at least one code section for wireless communication, the at least one code section being executable by a machine for causing the machine to perform steps comprising:
in an integrated FM radio transmitter and FM radio receiver system that shares a common local oscillator generator for driving said FM radio transmitter and said FM radio receiver:
generating within said local oscillator generator, a first signal; and
clocking said FM radio transmitter and said FM radio receiver via a frequency scaled version of said first signal.

12. The machine-readable storage according to claim 11, wherein said at least one code section comprises code for programmably scaling a frequency of said generated local oscillator signal.

13. The machine-readable storage according to claim 11, wherein a frequency of said first signal is in a frequency range of about 990 MHz to 1190 MHz.

14. The machine-readable storage according to claim 11, wherein a frequency of said frequency scaled version of said first signal is in a frequency range of about 76 MHz to 108 MHz.

15. The machine-readable storage according to claim 11, wherein said scaled version of said first signal comprise an in-phase component and a quadrature component.

16. The machine-readable storage according to claim 11, wherein said at least one code section comprises code for down-converting received FM radio signals utilizing said frequency scaled version of said first signal.

17. The machine-readable storage according to claim 11, wherein said at least one code section comprises code for up-converting FM radio signals for transmission utilizing said frequency scaled version of said first signal.

18. The machine-readable storage according to claim 11, wherein said at least one code section comprises code for receiving via said local oscillator generator, one or more signals generated via a fractional-N synthesizer.

19. The machine-readable storage according to claim 11, wherein said at least one code section comprises code for clocking said fractional-N synthesizer via a frequency scaled version of said first signal.

20. The machine-readable storage according to claim 11, wherein a frequency of said first signal is selected so that at least a first harmonic of said first signal does not fall within a frequency band utilized by a coexistent wireless technology.

21. A system for wireless communication, the system comprising:
one or more processors in an integrated FM radio system, the system comprising an FM radio transmitter and FM radio receiver that shares a common local oscillator generator for driving said FM radio transmitter and said FM radio receiver, wherein said one or more processors enable:
generation of a first signal within said local oscillator generator; and
clocking of said FM radio transmitter and said FM radio receiver via a frequency scaled version of said first signal.

22. The system according to claim 21, wherein said one or more processors enable programmably scaling a frequency of said generated local oscillator signal.

23. The system according to claim 21, wherein a frequency of said first signal is in a frequency range of about 990 MHz to 1190 MHz.

24. The system according to claim 21, wherein a frequency of said frequency scaled version of said first signal is in a frequency range of about 76 MHz to 108 MHz.

25. The system according to claim 21, wherein said scaled version of said first signal comprise an in-phase component and a quadrature component.

26. The system according to claim 21, wherein said one or more processors enable down-conversion of received FM radio signals utilizing said frequency scaled version of said first signal.

27. The system according to claim 21, wherein said one or more processors enable up-conversion of FM radio signals for transmission utilizing said frequency scaled version of said first signal.

28. The system according to claim 21, wherein said one or more processors enable receiving via said local oscillator generator, one or more signals generated via a fractional-N synthesizer.

29. The system according to claim 21, wherein said one or more processors enable clocking said fractional-N synthesizer via a frequency scaled version of said first signal.

30. The system according to claim 21, wherein a frequency of said first signal is selected so that at least a first harmonic of said first signal does not fall within a frequency band utilized by a coexistent wireless technology.
